(19) United States
(12) Patent Application Publication
(10) Pub. No.: US 2016/0106119 A1
(43) Pub. Date: Apr. 21, 2016

(54) PRODUCT PREPARATION AND COOKING ASSEMBLY

(71) Applicant: General Mills, Inc., Minneapolis, MN (US)

(72) Inventors: Aaron J. BAUMGARTNER, Savage, MN (US); Braden J. ERICKSON, Eden Prairie, MN (US); Penny L. NORQUIST, St. Paul, MN (US)

(73) Assignee: General Mills, Inc.

(21) Appl. No.: 14/516,607

(22) Filed: Oct. 17, 2014

(51) Int. Cl. A23C 19/09; A23P 1/10

(52) U.S. Cl. CPC A23C 19/0912; A23P 1/105

(57) ABSTRACT

An array of wells formed in a flexible mold is filled to a uniform depth with cheese by positioning an insert, including a funnel array established by a plurality of spaced funnel members, upon the mold such that each funnel member is in alignment with, freely received within, and supported upon a bottom wall of a respective well. Thereafter, cheese is provided on the insert to fill each funnel member. Next, the insert is removed, causing the cheese within the funnel members to partially and uniformly fill the wells. The cheese is then cooked in the mold, with the cheese being retained below open tops of the wells. Grease developed during the cooking process forms a layer upon the cheese within each well and, during a subsequent cooling process, the grease is drawn back into the produced cheese crisps. Finally, the crisps are removed by flexing the mold.

### BACKGROUND OF THE INVENTION

The invention generally pertains to the art of food preparation and, more specifically, to the structure and method of using a mold and insert assembly in the preparation and cooking of cheese snack products. The invention is particularly directed to making baked cheese snack products in the form of thin, crispy cheese snacks or crisps.

Certainly, there exists a wide range of snack products on the market, as well as an abundance of ways in which to form the snack products. One type of known snack is a cooked snack product or crisp made from cheese. For instance, it is known to produce a dried cheese snack product in the form of a crisp by depositing a hot emulsion of processed cheese onto a cooking surface, subjecting the processed cheese to a microwave cooking step wherein moisture is removed, and cooling the emulsion to establish individual, cooked, dried cheese products in the form of crisps. This operation can be performed as a batch process or, in connection with high throughput manufacturing of such snack products, as a continuous process. Presumably, as an alternative to depositing a cheese containing emulsion onto the cooking surface, small blocks of cheese could also be employed with comparable results.

In each of these scenarios, the cooking of the cheese emulsion or blocks will develop grease, including oils and the like, which splatters during the cooking process. In addition, the various deposited cheese bodies are non-uniform in shape such that the resulting products undesirably differ in size, as well as texture. In particular, the resulting products will not only differ in their footprints, but also in the amount of doming which occurs during the cooking process. Furthermore, due to varying expansion, adjacent cheese bodies can often become undesirably interconnected during the cooking process, a phenomena referred to as webbing.

### SUMMARY OF THE INVENTION

In accordance with the invention, a flexible mold formed with an array of cheese receiving wells is used in combination with an insert including a funnel array to initially fill the wells to a uniform depth with cheese. More specifically, the funnel array includes a plurality of spaced funnel members which are arranged about a plate, with each funnel member being configured to be in alignment with, freely received within, and supported upon a bottom wall of a respective well of the mold when the insert is placed on the mold. Thereafter, cheese, either in shredded or block form, is provided on the plate of the funnel array and used to fill each funnel member, with the excess cheese being removed from atop the insert. Next, the insert is removed, causing the cheese to be dispensed from within each funnel member to partially fill a respective well. Each funnel member is specifically sized relative to a respective well such that a calibrated amount of cheese will be provided and the wells will be uniformly, partially filled. In a preferred embodiment, between half and three fourths (½-¾) of the depth of each well is filled.

At this point, the cheese is ready to be cooked, with the mold be positioned directly in a cooking unit, preferably for exposure to a baking process. During the cooking process, the cheese softens and, in certain preferred embodiments, such as when using hard or soft natural cheeses like cheddar, Monterey Jack or certain reduced or full fat cheeses, the cheese melts. In any case, since the cheese is retained below the open tops of the wells, the grease developed during the cooking process forms a layer upon the cheese body within the well, instead of splattering over the top surface of the mold. Following cooking, the products in the wells are allowed to cool and dry, during which time the grease is drawn back or soaks into the products. Finally, the mold can be flexed to readily remove the individual cheese snack products or crisps from the various wells.

The result is the production of cheese crisps which are consistent in finish. More specifically, the products experience even cooking, no webbing develops between the individual products during cooking, the grease is contained, the formed crisps can be conveniently removed from the flexible mold, and the final crisps are uniform in size and texture.

Additional objects, features and advantages of the invention will become more readily apparent from the following detailed description of the invention wherein like reference numerals refer to corresponding components in the several views.

### BRIEF DESCRIPTION OF THE DRAWINGS

FIG. 1 is an exploded view of a lower mold and an upper insert forming a product preparation and cooking assembly in accordance with the invention.

FIG. 2 is a partial cross-sectional view of the assembly of FIG. 1, with the insert being positioned upon the mold.

FIG. 3A is a perspective view of a mold and insert assembly constructed in accordance with the invention which is shown smaller than the assembly of FIGS. 1 and 2 for use in describing an initial assembly stage of the preparation and cooking operation.

FIG. 3B illustrates the mold and insert assembly of FIG. 3A in a fill stage of the preparation and cooking operation.

FIG. 3C illustrates the mold of FIGS. 3A and 3B during a cooking stage.

FIG. 3D illustrates a crisp removal stage following both the cooking stage and a subsequent cooling and drying stage.

FIG. 4 illustrates the mold and insert assembly of FIG. 3B but wherein cheese blocks are employed in the fill stage.

### DETAILED DESCRIPTION OF EMBODIMENTS

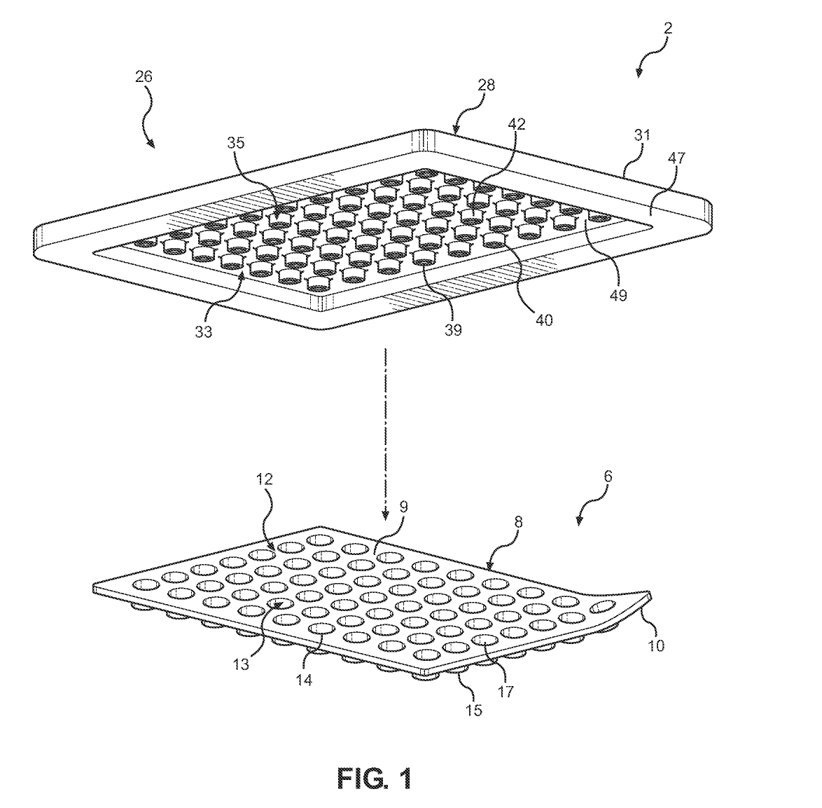

With initial reference to FIG. 1, an embodiment of the product preparation and cooking assembly of the invention is generally indicated at 2. As shown, assembly 2 includes a mold 6 having a base 8 defining a top surface 9 and a bottom surface 10. Base 8 is provided with an array of cavities or wells 12, with each well 13 including an open top 14 along top surface 9, a bottom wall 15 and at least one side wall 17. In this preferred embodiment, the at least one side wall 17 constitutes an annular side wall such that the well 13 has an associated diameter, along with an associated depth. For reasons which will become more fully evident below, mold 6 is made of a flexible material, such as silicone.

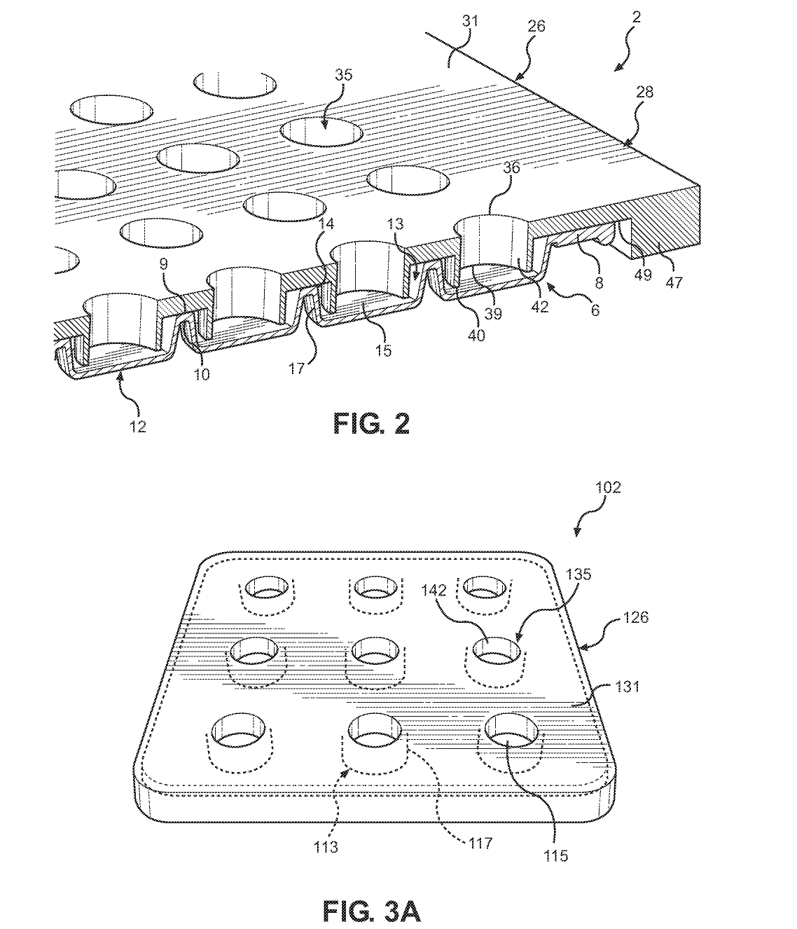

Assembly 2 also incorporates an insert 26 including a plate 28 having an upper surface 31. Spaced about upper surface 31 is a funnel array 33 including a plurality of funnel members 35. Each funnel member 35 includes an upper opening 36 (see FIG. 2) along upper surface 31, a lower opening 39 defined by a lowermost edge 40, and at least one side wall 42. In a manner similar to wells 13 of mold 6, the at least one side wall 42 of each funnel member 35 preferably constitutes an annular wall such that funnel member 35 has an associated diameter, along with an associated length or depth. In the embodiment shown, plate 28 of insert 26 includes an outer peripheral portion 47 which is thicker than a central, recessed portion 49 in which funnel array 33 is formed.

As shown in FIG. 2, insert 26 is adapted to be positioned upon mold 6 with each funnel member 35 being configured to be in alignment with, freely received within, and supported upon bottom wall 15 of a respective well 13 of mold 6. More specifically, the diameter of the annular side wall 42 of each funnel member 35 is less than the diameter of the annular side wall 17 of a respective well 13, such that the funnel member 35 can be freely received in a respective well 13, with the lowermost edge 40 resting upon bottom wall 15 as shown. At the same time, plate 28 rests on top surface 9, and mold 6 is encompassed by outer peripheral portion 47.

At this point, it should be noted that the particular geometric shapes of wells 13 and funnel members 35 can vary without departing from the invention. However, in accordance with the most preferred embodiment of the invention as will be described in further detail below, it is desired to produce circular cheese crisps, hence the employment of annular side walls 17 and 42. In addition, the side walls 17 and 42 can be uniform or tapered (angled). For instance, in the particular embodiment shown, annular side wall 17 of each well 13 is actually angled upwardly and outwardly so that the diameter of open top 14 is greater than bottom wall 15, while annular side wall 42 of insert 26 has a uniform diameter from upper opening 36 to lower opening 39.

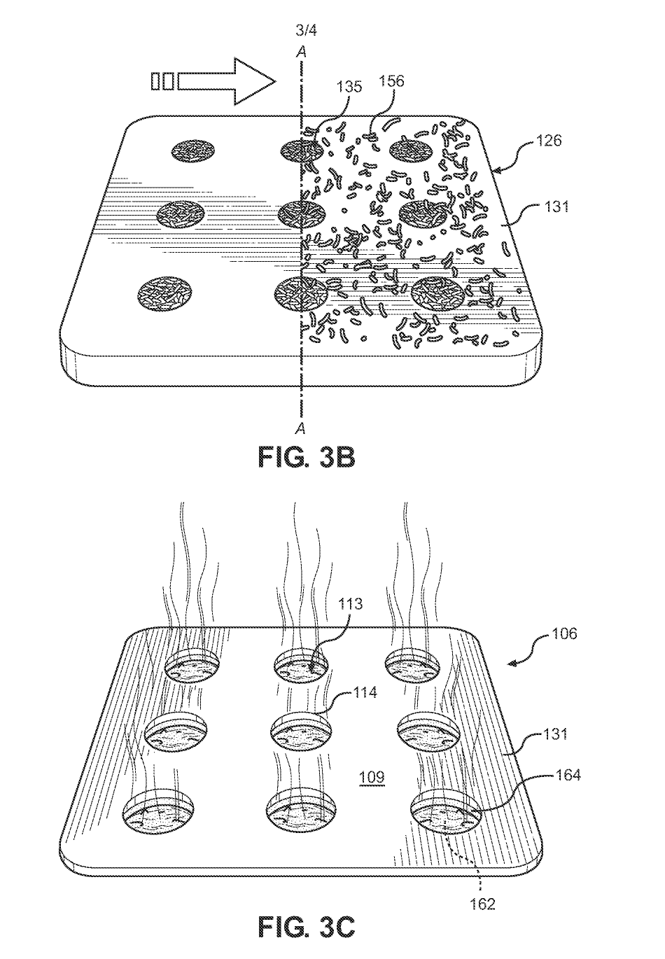

Reference will now be made to FIGS. 3A-3D in describing the manner in which the assembly is utilized in forming cheese snack products in accordance with the invention. For purposes of this description, a mold and insert with smaller arrays are shown in these figures, with corresponding structure to the embodiment of FIGS. 1 and 2 being referenced with numerals increased by 100. Therefore, in FIG. 3A, a product preparation and cooking assembly 102 includes an insert 126 having an upper surface 131 provided with a plurality of spaced funnel members 135 having annular side walls 142 which rest upon bottom walls 115 of wells 113. As exemplified in FIG. 3B, a subsequent preparation phase constitutes a fill stage wherein cheese, specifically shredded cheese 156 in this embodiment, is supplied onto upper surface 131 of insert 126, wherein the cheese 156 is received within and fills the funnel members 135 substantially level with upper surface 131. For illustrative purposes in this figure, to the left of line A-A, excess cheese 156 has been scraped or otherwise removed from upper surface 131, while to the right of line A-A, excess cheese 156 still remains. As the funnel members 135 are supported directly within the wells 113, the cheese 156 is fully contained within the funnel members 135. At this point, the insert 126 is lifted and removed from upon mold 106, causing the cheese 156 within each funnel member 135 to only partially fill a respective well 112. That is, funnel members 135 are sized such that a calibrated amount of cheese which completely fills the funnel members 135 only partially and uniformly fills the wells 113 which are larger in volume. This is clearly shown in FIG. 3C. In a preferred embodiment, only between half and three fourths (½-¾) of the depth of each well 113 is filled and, most preferably, only about half. For example, in certain embodiments, this amount is in the order of 2-3 grams of cheese, with one particular embodiment employing about 2.4 grams of cheese per funnel member 135/well 113.

At this point, the cheese 156 is actually ready to be cooked, with the cheese 156 being heated directly in mold 106 during a cooking stage as represented in FIG. 3. For instance, mold 106 can be directly placed in an oven, either in a batch or continuous cooking process, for exposure to a baking process. During the cooking process, the cheese 156 softens and, in certain preferred embodiments, such as when using hard or soft natural cheeses like cheddar, Monterey Jack or certain reduced or even full fat cheeses, the cheese 156 melts, forming a cheese body 162. In addition, grease 164 developed during the cooking process forms a layer upon the cheese body 162 within each well 113. Since the cheese body 162 is retained below the open tops 114 of the wells 113, the grease 164 developed during the cooking stage does not splatter over the top surface 109 of mold 106. In addition, the cheese body 162 stays within the wells 112 such that no product webbing between the wells 112 occurs.

Following cooking, the cheese products in the wells 112 are allowed to cool and dry, during which time the grease 164 is drawn or soaks back into the products, generally within about 15 seconds. Upon cooling, the desired cheese crisps 170 of the invention are established as shown in FIG. 3D. Finally, mold 106 can be flexed, as also shown in FIG. 3D, to readily remove the individual cheese crisps 170 from the various wells 113.

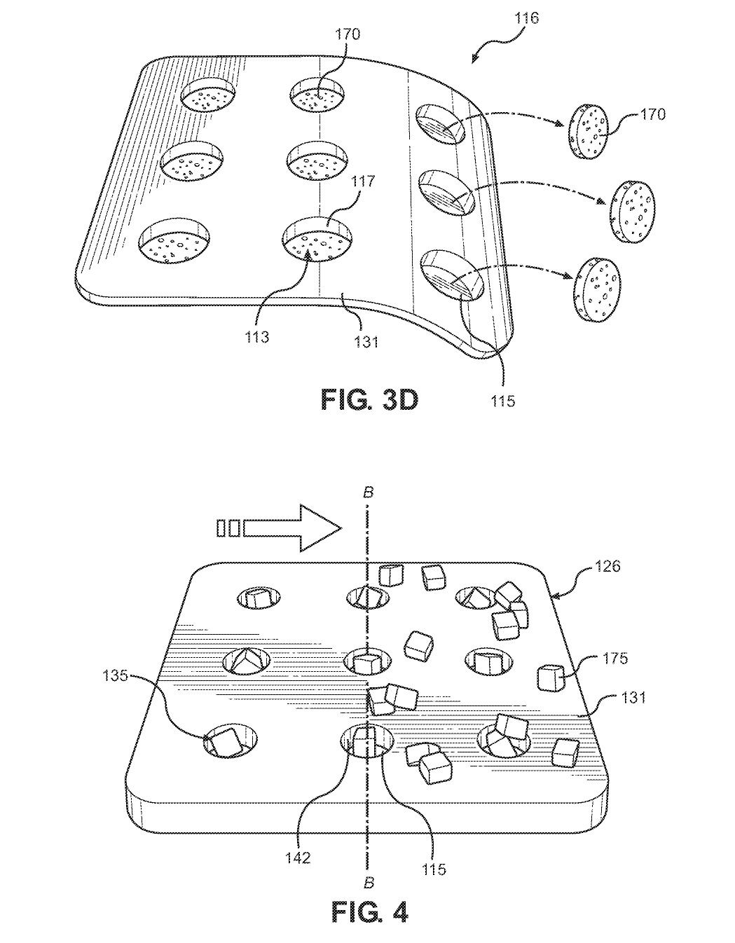

The result is the production of cheese crisps which are consistent in finish. More specifically, the products experience even cooking, no webbing develops between the individual products during cooking, the grease is contained, the formed crisps can be conveniently removed from the flexible mold, and the final crisps are uniform in size and texture. Still, although described with respect to preferred embodiments of the invention, it should be understood that various changes and/or modifications can be made without departing from the spirit of the invention. For instance, although the above discussion refers to filling the wells with shredded cheese 156, other forms of cheese, including cheese cubes 175 as shown in FIG. 4, could also be employed, with excess calibrated sized cheese cubes 175 being shown removed from upon upper surface 131 on the left of line B-B. Cheese granules could also be employed. In addition, although melting cheeses are preferred, certain non-melting, specialty cheese could also be utilized. Furthermore, although the material for the mold is optimally silicone, other materials could be employed.

1. A method of preparing and cooking cheese crisps comprising:
positioning an insert, including an array of funnel members, upon a mold, including an array of wells, such that each of the funnel members is freely received in a respective one of the wells;
supplying cheese into the array of funnel members;
removing the insert from upon the mold, causing the cheese within each funnel member to only partially fill a respective said well of the array of wells;
heating the cheese in the mold;
allowing the cheese to cool within the mold to form cheese crisps; and
removing the cheese crisps from the mold.

2. The method of claim 1, wherein supplying cheese into the array of funnel members includes uniformly filling each of the funnel members with a calibrated amount of cheese.

3. The method of claim 2, wherein the cheese is supplied as shredded cheese.

4. The method of claim 2, wherein the cheese is supplied as cubes or granules of cheese.

5. The method of claim 2, wherein filling each of the funnel members includes placing a quantity of cheese on an upper surface of the insert, spreading the cheese into the funnel members and removing excess cheese from the upper surface.

6. The method of claim 2, wherein, upon removing the insert, each of the wells is no more than three-quarters full of the cheese.

7. The method of claim 6, wherein each of the wells receives between 2-3 grams of cheese.

8. The method of claim 1, wherein positioning the insert upon the mold includes resting lowermost edges of the funnel members on bottom walls of the wells.

9. The method of claim 1, further comprising: upon heating the cheese, developing grease upon the cheese within the wells, with the grease be retained below open top portions of the wells.

10. The method of claim 9 wherein, upon cooling the cheese, the grease soaks into the cheese crisps.

11. The method of claim 1 wherein, after cooling, the cheese crisps are recessed within the wells such that no webbing exists between the cheese crisps of adjacent ones of the wells.

12. The method of claim 1, wherein removing the cheese crisps from the mold includes flexing the mold.

13. The method of claim 1, wherein the step of supplying cheese includes supplying a melting cheese into the array of funnel members.

14. A product preparation and cooking assembly comprising:
a mold including a base and an array of wells, with each well having a bottom wall, at least one side wall, and an open top; and
an insert including a plate and an array of funnel members, with each funnel member having a lower opening, at least one side wall with a lowermost edge, and an upper opening, wherein the insert is configured such that, upon being placed on the mold, each of the funnel members is aligned with a respective one of the wells and sized to be freely received in the respective one of the wells.

15. The product preparation and cooking assembly of claim 14, wherein the insert is configured such that, upon being placed on the mold, the lowermost edge of the at least one side wall of each funnel member rests on the bottom wall of the respective one of the wells.

16. The product preparation and cooking assembly of claim 15, wherein the insert is further configured such that, upon completely filling each of the funnel members with a food product and removing the insert from upon the mold, the food product only partially fills each of the wells.

17. The product preparation and cooking assembly of claim 14, wherein the mold is made of a flexible material.

18. The product preparation and cooking assembly of claim 17, wherein the flexible material is silicone.

19. The product preparation and cooking assembly of claim 14, wherein the at least one side wall of each well and the at least one side wall of each funnel member constitutes an annular side wall, with a diameter of the at least one side wall of each funnel member being less than a diameter of the at least one side wall of each well.

20. The product preparation and cooking assembly of claim 14, the annular side wall of each well angles upwardly and outwardly from the bottom wall.
